(19) United States
(12) Patent Application Publication
(10) Pub. No.: US 2016/0256871 A1
(43) Pub. Date: Sep. 8, 2016

(54) DEVICE AND ASSEMBLY FOR LOCKING THE BOWL LINER OF A ROCK CRUSHER

(71) Applicant: Jerrod Dulmes, New Berlin, WI (US)

(72) Inventor: Jerrod Dulmes, New Berlin, WI (US)

(21) Appl. No.: 15/061,061

(22) Filed: Mar. 4, 2016

Related U.S. Application Data
(60) Provisional application No. 62/128,607, filed on Mar. 5, 2015.

(51) Int. Cl. B02C 2/00

(52) U.S. Cl. CPC B02C 2/005

(57) ABSTRACT

A wedge device is movable to alternatively engage and disengage the upper portion of the bowl liner of a crusher. The wedge device comprises a wedge having a forward portion and a cavity configured to receive a cylinder. At the rearward portion of the wedge device is a bolt. A threaded end of the bolt is configured to mate with a like-threaded nut. The wedge device is positioned such that the head of the bolt contacts an outer surface of the crusher. A cylinder is placed within the cavity. When the cylinder is pressurized, the wedge nose engages the bowl liner. The nut is then easily rotated and moved into a “holding” position behind the rearward portion of the wedge. The cylinder can then be removed from the wedge cavity and moved for use with another wedge device. A lock plate can be used to prevent rotation of the nut.

This application claims the benefit and priority of U.S. Provisional Patent Application No. 62/128,607 filed Mar. 5, 2015.

### FIELD OF THE INVENTION

This invention relates generally to machines of the type that are often referred to as rock “crushers,” which are constructed to apply mechanical force to rocks so as to break them into smaller rocks. Rock crushing machines typically place rocks between two solid surfaces and then apply sufficient pressure to bring the surfaces together and fracture the rocks disposed between the surfaces into a size that is desired or required. More specifically, this invention relates to a “cone” crusher which uses a wear resistant mantle and a bowl liner to crush the rock. The present invention relates to an improved wedge device and assembly that is used to lock the bowl liner into a fixed position.

### BACKGROUND OF THE INVENTION

As alluded to above, a cone crushing machine (also referred to herein as a “cone crusher” or, simply, a “crusher”) breaks rocks by squeezing the rocks between an eccentrically gyrating and wear resistant mantle and an enclosing concave hopper, which is covered by a bowl liner. During use, rocks are fed into the top, or hopper assembly, of the crusher. As gravity draws the rocks downwardly, they become wedged and then squeezed between the mantle and the bowl liner until they are broken. As the rocks are broken into smaller pieces, these smaller pieces drop down into the crusher, their size being further reduced by further squeezing and fracturing, which continues until the rock pieces are small enough to fall through an opening at the bottom of the crusher.

During the useful life of the crusher, the bowl liner will wear to the point that it needs to be replaced. In a typical crusher, the bowl liner is retained in position by using a plurality of wedges that are placed about the upper perimeter of the bowl liner. Such wedges typically are moveable and engages an upper portion of the bowl liner. In order to place the bowl liner into the crusher, or to release the bowl liner from the crusher, the wedge must be withdrawn away from the bowl liner. This is typically accomplished by using bolt and nut adjustment elements. In order to tighten or loosen the nut, an open-ended wrench can be used. Use of such a tool is fine for small crushers. In large crushers, however, it is not uncommon to have a rather large open-ended wrench (which can be several feet long) placed on the nut. In order to tighten the nut or to “break” the nut loose, the opposite end of the large wrench is often struck with a sledge hammer. This is an extremely dangerous process and typically requires at least two workers to implement it. In the view of this inventor, there is a need to improve on this manual method of rotating the nut so as to be able to withdraw the wedge away from the bowl liner such that the bowl liner can be released.

Accordingly, it is an object of the present invention to provide an improved wedge device that can be used with crushers and bowl liners of present and future manufacture. It is another object to provide such an improved wedge device that will function in substantially the same manner as wedges of the prior art while making the process of moving the wedge in relation to the bowl liner a much safer process. It is still another object to provide such an improved wedge device while maintaining some of the simplicity and integrity of wedges used in accordance with the prior art.

In the view of this inventor, there is a need for a simplified device and assembly that provides the necessary functionality as discussed above and which is relatively simple in construction and installation. In the experience of this inventor, such a device and assembly can be constructed and it is the subject of the present invention. The most significant advantage of the wedge device and assembly of the present invention, however, is that the force normally required to push the wedge is transferred from the tightening of a nut via a hand tool (which can be quite large and cumbersome) to a hydraulic cylinder that pushes the wedge and then requires only tightening of the nut by hand (or a tool, but with much less force than normally required). This places the nut where it needs to be without using the nut, in combination with a bolt, as the sole driving force for the wedge.

### SUMMARY OF THE INVENTION

The wedge device and assembly of the present invention provides a wedge being inwardly and outwardly movable. In this way, the wedge can alternatively engage and disengage an upper portion of a bowl liner, respectively. The wedge comprises a forward portion and a cavity that is disposed behind the forward portion, the cavity being configured to receive a cylinder within it. At the rearward portion of the wedge device is a bolt. The bolt used can be shorter than that normally required since the bolt does not need to bridge the gap created by the cavity and directly contact the wedge.

A threaded end of the bolt is configured to mate with a like-threaded nut. In application, the wedge device is positioned such that the head of the bolt contacts an outer surface of the crusher. The wedge of the wedge device is extended forwardly thereof by insertion of the cylinder into the cavity. When the cylinder is pressurized, the wedge engages a portion of the bowl liner. Once securely in place, the nut is easily rotated and moved into a “holding” position behind the rearward portion of the wedge. Once in place, the cylinder can be depressurized and removed from the wedge cavity and moved for use with another wedge device. The nut and bolt hold the wedge in place. A lock plate can be positioned about the nut to prevent rotation of the nut, the plate being held in position via a fastener.

The foregoing and other features of the present invention will be apparent from the detailed description that follows.

### BRIEF DESCRIPTION OF THE DRAWINGS

FIG. 1 is a cross sectioned front, top and side view of an assembly that uses a plurality of wedge devices that are constructed in accordance with the present invention.

FIG. 2 is a slightly enlarged front, top and side view of a wedge device shown in FIG. 1.

### DETAILED DESCRIPTION

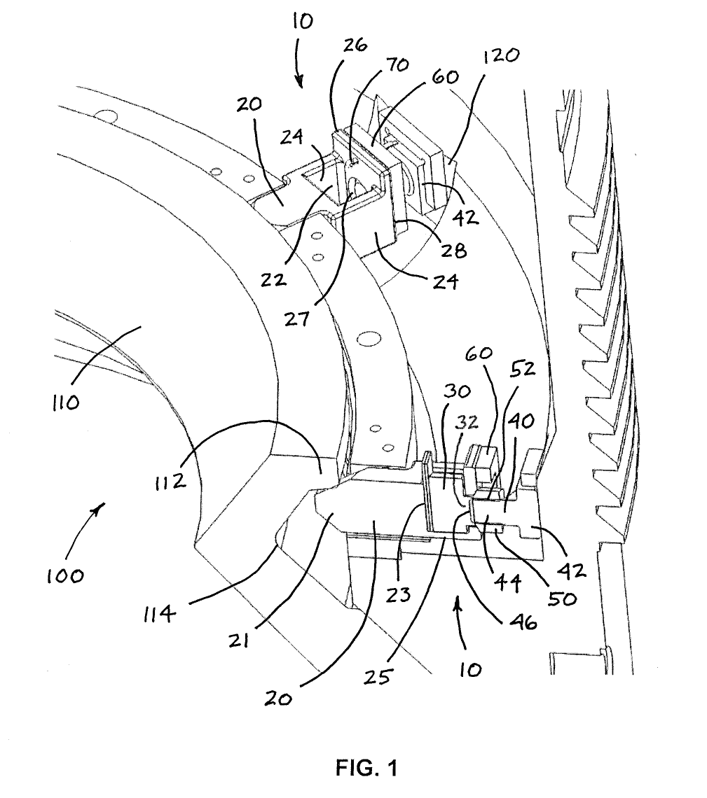

Referring now to the drawing in detail, FIG. 1 illustrates a plurality of wedge devices, each being generally identified 10, of the type that is constructed in accordance with the present invention. As shown, each wedge device 10 is part of an assembly, generally identified 100, where each wedge device 10 is positioned relative to a round bowl liner 110. Referring to FIG. 3, it will be seen that the bowl liner 110 comprises a circumferential top lip 112. Below the top lip 112 is a generally V-shaped circumferential recess 114.

More specifically, the wedge device 10 and assembly 100 of the present invention comprises a structure having a forwardly disposed wedge 20, the wedge 20 being inwardly and outwardly movable and configured with a V-shaped forward face or nose portion 21. The forward face or nose portion 21 is designed such that it can alternatively engage with, and disengage from, a portion the V-shaped recess 114 of the bowl liner 110, respectively. The wedge 20 further comprises a cavity 22 that is disposed to the rear of the forward face or nose portion 21 of the wedge 20.

In the preferred embodiment, the cavity 22 is defined by a forward wall 23, a pair of opposing side walls 24, a floor 25 and a rearward wall 26. The rearward wall 26 comprises a substantially circular aperture 27 that is defined within that rearward wall 26. The walls 23, 24, 26 and the floor 25 form the cavity 22 which is configured to receive a hydraulically-actuated cylinder 30 within it, the cylinder 30 further including a plunger 32. The cavity 22 could be alternatively configured, such as by being cylindrical or half-pipe shaped, to receive a variety of cylinders 30 of current manufacture, the cavity 22 substantially conforming in shape to the outer profile of such other cylinders 30. It is also to be noted that the precise type of cylinder 30 and its actuation means, be it hydraulic, pneumatic or some other means, is not a limitation of the invention. The cylinder 30 shown in the enabled embodiment is a plunger cylinder 30 with a single plunger 32, as illustrated in FIG. 1.

At the rearward-most face 28 of the wedge 20 of the wedge device 10 is a bolt 40. The bolt 40 used can be shorter than that normally required since the bolt 40 does not need to bridge the gap created by the cavity 22 and directly contact the rearward surface 26 of the wedge 20. But this bolt length does depend on the distance between the forward wall 23 and the end 46 of the bolt 40. The bolt 40 comprises a rearwardly-disposed head 42, a threaded bolt portion 44 that extends forwardly of the bolt head 42 and, again, the bolt end 46 that is disposed opposite the bolt head 42. The threaded portion 44 of the bolt 40 is configured to mate with a like-threaded nut 50. The nut 50 comprises a threaded aperture 52, the threads of the aperture 52 matching the threads of the threaded portion 44 of the bolt 40.

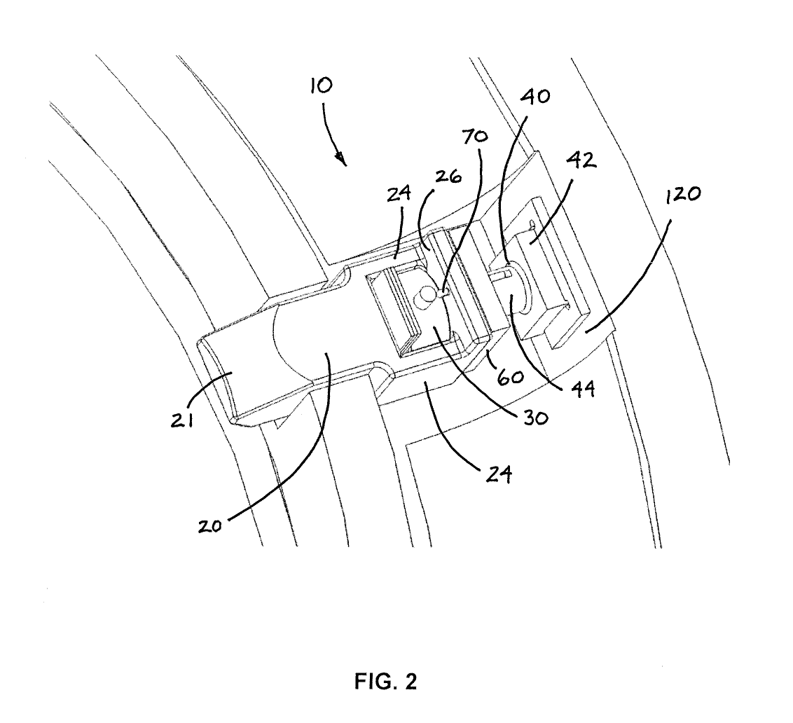

In application, the wedge device 10 is positioned such that the head 42 of the bolt 40 contacts an outer surface 120 of the crusher. The wedge 20 is movable forwardly by means of the cylinder 30 that is placed within the cavity 22. See also FIG. 2. The cylinder 30 is removable such that it can be used with other wedge devices 10 within the assembly 100. One side of the cylinder 30 engages the rearward surface 26 of the wedge 20. The opposing side of the cylinder 30 engages the bolt end 46. When the cylinder 30 within the cavity 22 is pressurized, the wedge 20 is urged away from the bolt end 46 via the plunger 32 to the point that the nose portion 21 of the wedge 20 engages a portion of the bowl liner 110. At the same time, the plunger 32 pushes against the bolt end 46 to urge the bolt head 42 to engage the outer surface 120 of the crusher. Once securely in this position, the nut 50 is able to be easily rotated about the threaded portion 44 of the bolt 40 and moved into a “holding” position behind the rearward surface 26 of the wedge 20.

At this point, the cylinder 30 can be depressurized, the plunger 32 returning to its depressurized position, and the cylinder 30 is removed from the wedge cavity 22. The cylinder 30 can then be moved for use with another wedge device 10 at another point about the perimeter of the bowl liner 110. This is repeated until all wedge devices 10 to be used are properly positioned and seated. The nut 50 and bolt 40 continue to hold the wedge 20 in place. A lock plate 60 can be positioned about the nut 50 to prevent rotation of the nut 50, the plate 60 being held in position via a fastener 70.

During the opposite action, i.e. where the wedge devices 10 are to be sequentially backed away from the bowl liner 110, the cylinder 30 can be re-inserted into any cavity 22 of the cylinder 30 and then actuated. This removes pressure from the nut 50, allowing it to be rotated and moved toward the head 42 of the bolt 40.

In view of the foregoing, it will be apparent that there has been provided a new, useful and non-obvious wedge device and assembly that provides the functionality of securing a bowl liner within a rock crusher.

The details of the invention having been disclosed in accordance with the foregoing, I claim:

1. A wedge device for locking the bowl liner of a rock crusher comprising:
a wedge, the wedge comprising a forward portion, a rearward portion, a wedge cavity disposed between the forward and rearward wedge portions, and an aperture defined within the rearward portion of the wedge, the aperture extending through the rearward portion of the wedge to the wedge cavity;
a bolt having a head and an externally-threaded portion that extends forwardly of the bolt head;
a nut having an internally-threaded portion, the threaded portion of the nut being complementary to the threaded portion of the bolt; and
a cylinder, the cylinder disposed within the wedge cavity;
wherein the wedge is alternatively moveable inwardly and outwardly so as to engage and disengage the bowl liner of the crusher when the cylinder is pressurized and depressurized, respectively.

2. The device of claim 1 wherein the forward portion of the wedge further comprises a V-shaped forward nose portion.

3. The device of claim 1 wherein the wedge cavity is defined by a forward wall, a pair of opposing side walls, a floor and a rearward wall, the rearward wall comprising the aperture.

4. The device of claim 1 wherein the cylinder comprises an outer profile and the cavity of the wedge is configured to substantially conform in shape to the outer profile of the cylinder.

5. The device of claim 1 further comprising a lock plate positioned about the nut to prevent rotation of the nut, the lock plate being held in position via a fastener.

6. An assembly for locking the bowl liner of a rock crusher, the assembly comprising:
a bowl liner, the bowl liner comprising a circumferential top lip and a generally V-shaped circumferential recess disposed below the top lip;
an outer crusher surface;
a wedge disposed between the bowl liner and the outer crusher surface, the wedge comprising a forward portion having a V-shaped forward nose, a rearward portion, a wedge cavity disposed between the forward and rearward wedge portions, and an aperture defined within the rearward portion of the wedge, the aperture extending through the rearward portion of the wedge to the wedge cavity;
a bolt having a head and an externally-threaded portion that extends forwardly of the bolt head;
a nut having an internally-threaded portion, the threaded portion of the nut being complementary to the threaded portion of the bolt; and
a cylinder, the cylinder disposed within the wedge cavity;
wherein the V-shaped forward nose of the wedge is receivable within the V-shaped circumferential recess disposed below the top lip of the bowl liner; and
wherein the wedge is alternatively moveable inwardly and outwardly so as to engage and disengage the bowl liner of the crusher when the cylinder is pressurized and depressurized, respectively.

7. The assembly of claim 6 wherein the cavity is defined by a forward wall, a pair of opposing side walls, a floor and a rearward wall, the rearward wall comprising the aperture.

8. The assembly of claim 6 wherein the cylinder comprises an outer profile and the cavity of the wedge is configured to substantially conform in shape to the outer profile of the cylinder.

9. The assembly of claim 6 further comprising a lock plate positioned about the nut to prevent rotation of the nut, the lock plate being held in position via a fastener.

10. A method for locking the bowl liner of a rock crusher, the bowl liner comprising a circumferential top lip and a generally V-shaped circumferential recess disposed below the top lip, and the rock crusher further comprising an outer crusher surface, the method comprising the steps of:
providing a wedge, the wedge comprising a forward portion having a V-shaped forward nose, a rearward portion, a wedge cavity disposed between the forward and rearward wedge portions, and an aperture defined within the rearward portion of the wedge, the aperture extending through the rearward portion of the wedge to the wedge cavity;
providing a bolt having a head and an externally-threaded portion that extends forwardly of the bolt head;
providing a nut having an internally-threaded portion, the threaded portion of the nut being complementary to the threaded portion of the bolt;
attaching the nut to the threaded portion of the bolt such that the threaded portion of the bolt extends into a portion of the wedge cavity aperture;
positioning the wedge between the bowl liner and the outer crusher surface;
providing a cylinder;
removably placing the cylinder into the wedge cavity;
pressurizing the cylinder to urge the forward nose of the wedge into contact with bowl liner recess and to urge the head of the bolt into contact with the outer crusher surface;
rotating the nut about the threaded portion of the bolt thereby placing the wedge in a holding position;
depressurizing the cylinder; and
removing the cylinder from the wedge cavity.

11. The method of claim 10 further comprising, prior to the wedge positioning step, the steps of providing a lock plate and positioning the lock plate about the nut.

12. The method of claim 10 wherein the wedge providing step further comprises the step of providing a plurality of wedges and the method further comprising the step of sequentially positioning each wedge in the plurality of wedges and applying the remaining steps to each wedge via a single cylinder.

13. The method of claim 10 wherein the cylinder comprises a physical shape and the wedge providing step further comprises the step of providing a wedge cavity that matches the physical shape of the cylinder.

14. A method for locking the bowl liner of a crusher comprising the steps of:
providing a wedge having a cavity and a rearward-facing aperture;
providing a bolt having a head;
providing a nut that is complementary to the bolt;
providing a cylinder;
placing the cylinder into the wedge cavity;
placing the bolt and nut behind the wedge and into the wedge aperture;
pressurizing the cylinder; and
rotating the nut about the bolt to place the wedge in a holding position.

15. The method of claim 14 wherein the bolt providing step further comprises providing the bolt with an end opposite of the bolt head, wherein the cylinder providing step further comprises providing the cylinder with a plunger, and wherein the cylinder pressurizing step further comprises urging the plunger against the bolt end.

16. The method of claim 14 wherein the cylinder comprises an outer profile and the wedge providing step further comprises the step of providing a wedge cavity that is configured to substantially conform in shape to the outer profile of the cylinder.

17. The method of claim 14 further comprising the steps of:
depressurizing the cylinder; and
removing the cylinder from the wedge cavity.
